(19) United States
(12) Patent Application Publication
(10) Pub. No.: US 2026/0307810 A1
(43) Pub. Date: Oct. 8, 2026

(54) BUSTLE INSTALLATION BLOCKER

(71) Applicant: Goodrich Corporation, Charlotte, NC (US)

(72) Inventors: Blake Evans, Sun City West, AZ (US); Steven T. Evans, Sun City, AZ (US); Craig Prevost, Surprise, AZ (US); Nicolas J. Ruegsegger, Peoria, AZ (US); Stephen J. Early, Mesa, AZ (US)

(73) Assignee: Goodrich Corporation, Charlotte, NC (US)

(21) Appl. No.: 19/578,581

(22) Filed: Mar. 25, 2026

Related U.S. Application Data
(60) Provisional application No. 63/782,986, filed on Apr. 3, 2025.

(51) Int. Cl. B64D 25/14; F16B 19/02

(52) U.S. Cl. CPC B64D 25/14; F16B 19/02

(57) ABSTRACT

A system for preventing installation of a bustle until an evacuation slide assembly is enabled. The system includes the evacuation slide assembly, a latch safety pin mechanically coupled to a latch that is coupled to a soft cover of the evacuation slide assembly; and a regulator safety pin mechanically coupled to a regulator of the evacuation slide assembly. Responsive to removing the latch safety pin thereby allowing the soft cover to release in an emergency event, the latch safety pin is mechanically coupled to the regulator safety pin thereby allowing the regulator safety pin to be removed allowing a charged cylinder to activate in the emergency event.

### CROSS-REFERENCE TO RELATED APPLICATIONS

This application claims priority to and the benefit of, U.S. Provisional Application No. 63/782,986, filed Apr. 3, 2025, and entitled “BUSTLE BLOCKER,” which is incorporated by reference herein in its entirety for all purposes.

### FIELD

The present disclosure generally relates to aircraft evacuation slides and/or slide/rafts, and more specifically, to a bustle blocker for preventing installation of a bustle within an aircraft until safety pins are removed.

### BACKGROUND

Currently, bustles for aircraft evacuation slides and/or slide/rafts may be installed without the removal of safety pins that prevent the operation of the aircraft evacuation slide and/or slide/raft. Therefore, safety pins that remain installed during flight pose a risk to those on board in the event of an emergency evacuation as the aircraft evacuation slide and/or slide/raft would not inflate.

### SUMMARY

A system for preventing installation of a bustle until an evacuation slide assembly is enabled is disclosed herein. The system includes the evacuation slide assembly, a latch safety pin mechanically coupled to a latch that is mechanically coupled to a soft cover of the evacuation slide assembly, and a regulator safety pin mechanically coupled to a regulator of the evacuation slide assembly. Responsive to removing the latch safety pin thereby allowing the soft cover to release in an emergency event, the latch safety pin is mechanically coupled to the regulator safety pin thereby allowing the regulator safety pin to be removed allowing a charged cylinder to activate in the emergency event.

In various embodiments, a distal end of the latch safety pin, responsive to being inserted into a proximal end of the regulator safety pin, causes a set of detent balls adjacent a distal end of the regulator safety pin to be retracted.

In various embodiments, the set of detent balls adjacent the distal end of the regulator safety pin are retracted in response to the distal end of the latch safety pin interfacing with a tip of an internal rod in the regulator safety pin thereby translating the internal rod away from the proximal end of the regulator safety pin thereby causing the set of detent balls adjacent the distal end of the regulator safety pin to be retracted.

In various embodiments, the set of detent balls adjacent the distal end of the regulator safety pin is retracted into a sleeve at the distal end of the regulator safety pin.

In various embodiments, prior to being retracted, the set of detent balls adjacent the distal end of the regulator safety pin expand within a housing of the regulator keeping the regulator safety pin engaged and prevent the charged cylinder from activating.

In various embodiments, the set of detent balls adjacent the distal end of the regulator safety pin expand within the housing through a sleeve at the distal end of the regulator safety pin.

In various embodiments, a second set of detent balls adjacent the distal end of the latch safety pin is configured to retract in response to being inserted into the proximal end of the regulator safety pin and latch into a recess adjacent the proximal end of the regulator safety pin.

In various embodiments, the evacuation slide assembly is located within a compartment of an aircraft.

In various embodiments, the evacuation slide assembly is located within a compartment on an entry/exit door of an aircraft.

In various embodiments, the regulator safety pin is configured to be mechanically coupled to the regulator of the evacuation slide assembly via an opening in the compartment of the entry/exit door of the aircraft.

Also disclosed herein is an aircraft. The aircraft includes an entry/exit door and a system for preventing installation of a bustle until an evacuation slide assembly is enabled. The system includes the evacuation slide assembly, a latch safety pin mechanically coupled to a latch that is mechanically coupled to a soft cover of the evacuation slide assembly, and a regulator safety pin mechanically coupled to a regulator of the evacuation slide assembly. Responsive to removing the latch safety pin thereby allowing the soft cover to release in an emergency event, the latch safety pin is mechanically coupled to the regulator safety pin thereby allowing the regulator safety pin to be removed allowing a charged cylinder to activate in the emergency event.

In various embodiments, a distal end of the latch safety pin, responsive to being inserted into a proximal end of the regulator safety pin, causes a set of detent balls adjacent a distal end of the regulator safety pin to be retracted.

In various embodiments, the set of detent balls adjacent the distal end of the regulator safety pin are retracted in response to the distal end of the latch safety pin interfacing with a tip of an internal rod in the regulator safety pin thereby translating the internal rod away from the proximal end of the regulator safety pin thereby causing the set of detent balls adjacent the distal end of the regulator safety pin to be retracted.

In various embodiments, the set of detent balls adjacent the distal end of the regulator safety pin are retracted into a sleeve at the distal end of the regulator safety pin.

In various embodiments, prior to being retracted, the set of detent balls adjacent the distal end of the regulator safety pin expand within a housing of the regulator keeping the regulator safety pin engaged and prevent the charged cylinder from activating.

In various embodiments, the set of detent balls adjacent the distal end of the regulator safety pin expand within the housing through a sleeve at the distal end of the regulator safety pin.

In various embodiments, a second set of detent balls adjacent the distal end of the latch safety pin are configured to retract in response to being inserted into the proximal end of the regulator safety pin and latch into a recess adjacent the proximal end of the regulator safety pin.

In various embodiments, the evacuation slide assembly is located within a compartment of the aircraft.

In various embodiments, the evacuation slide assembly is located within a compartment on the entry/exit door of the aircraft.

In various embodiments, the regulator safety pin is configured to be mechanically coupled to the regulator of the evacuation slide assembly via an opening in the compartment of the entry/exit door of the aircraft.

The present disclosure may include any one or more of the individual features disclosed above and/or below alone or in any combination thereof. The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a perspective view of an aircraft having an evacuation assembly, in accordance with various embodiments.

FIGS. 2A and 2B illustrate an evacuation slide assembly, in accordance with various embodiments.

FIG. 3 illustrates an isometric view an evacuation slide assembly that includes either an aircraft evacuation slide and/or slide/raft, in accordance with various embodiments.

FIG. 4 illustrates an isometric view of the regulator safety pin installed though a compartment in which the evacuation slide assembly is installed and into a regulator, in accordance with various embodiments.

FIG. 5 illustrates a side view of a regulator safety pin installed though a compartment in which the evacuation slide assembly is installed, in accordance with various embodiments.

FIGS. 6A, 6B, and 6C illustrate isometric views of the removal of a regulator safety pin using a latch safety pin, in accordance with various embodiments.

FIGS. 7A and 7B illustrate a cross-section view depicting the interface between a latch safety pin and a regulator safety pin, in accordance with various embodiments.

FIGS. 8A and 8B illustrate a cross-section view depicting the interface between a regulator safety pin and a regulator, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

As stated previously, safety pins, which prevent the inflation of the aircraft evacuation slide and/or slide/raft, that remain installed during flight pose a risk to those on board in the event of an emergency evacuation as the aircraft evacuation slide and/or raft would not inflate. The illustrative embodiments provide, in various embodiments, a first regulator safety pin, which prevents a charged cylinder from firing, configured with a modified head which is a receptacle for a second latch safety pin, which prevents release of a latch that prevents the release of a soft cover for the aircraft evacuation slide and/or slide/raft. The second safety pin, in various embodiments is configured to act as a “key” to remove the first safety pin and the second safety pin simultaneously in response to being acted upon by the insertion of the second safety pin into the modified head. The first safety pin is configured to replace a typical regulator safety pin and is long enough to extend beyond the slide pack and interfere with the bustle's path of install with both safety pins installed. A bustle is cover for a protruding, packed compartment housing the aircraft evacuation slide and/or slide/raft that is located either on an interior of emergency exit door of an aircraft or adjacent to interior of emergency exit door of an aircraft. In various embodiments, the regulator safety pin may be manufactured from stainless steel, aluminum alloy, titanium, or other suitable materials capable of withstanding the mechanical stresses associated with repeated insertion and removal cycles. The length of the regulator safety pin may vary depending on the specific aircraft door configuration and compartment depth, but in various embodiments, the regulator safety pin extends at least 0.5 inches (approximately 12.7 mm) beyond the outer surface of the compartment to provide sufficient interference with the bustle installation path.

The operational sequence for implementing the bustle blocker system, in various embodiments, includes evacuation slide assembly packing with the soft cover secured by lacing. Then, the regulator safety pin is inserted through the opening in the compartment and into the regulator, with the distal end engaging the regulator housing via the detent ball mechanism. Then, the streamers attached to both safety pins are threaded through the elastics and connected to the “REMOVE BEFORE FLIGHT” rigid card. The latch safety pin is installed into the latch housing of the soft cover to secure the key-loop of the lacing. In response to preparing the aircraft for flight, the latch safety pin is removed from the latch housing and a rigid card is removed. The latch safety pin is then inserted into the proximal end of the regulator safety pin, which translates the internal rod and retracts the detent balls, allowing the regulator safety pin to be withdrawn. Only after both pins are removed can the bustle be installed over the evacuation slide assembly.

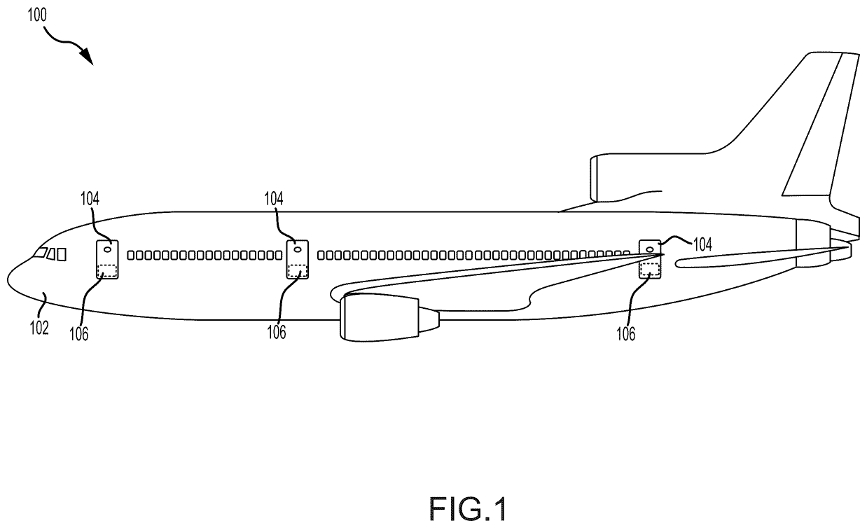

Referring now to FIG. 1, a perspective view of an aircraft having an evacuation assembly is illustrated, in accordance with various embodiments. Aircraft 100 includes a fuselage 102 having plurality of entry/exit doors 104. Aircraft 100 includes one or more evacuation systems coupled to a corresponding entry/exit door 104. For example, aircraft 100 includes evacuation systems 106 individually coupled to an interior of entry/exit doors 104. In the event of an emergency, entry/exit doors 104 may be opened by a passenger or crew member of aircraft 100. Evacuation systems 106 may deploy in response to an associated entry/exit door 104 being opened and/or in response to another action taken by a passenger or crew member such as, for example, depression of a button or actuation of a lever.

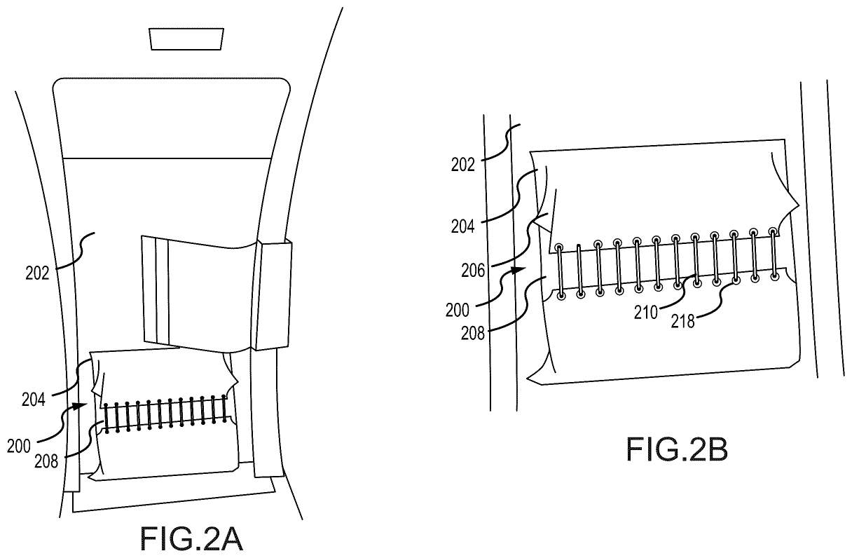

Referring now to FIGS. 2A and 2B, an evacuation slide assembly is illustrated, in accordance with various embodiments. The evacuation slide assembly 200 includes a door exit evacuation slide 208 stored in an uninflated condition within a compartment 204 on an aircraft entry/exit door 202, such as entry/exit door 104 of FIG. 1. The compartment 204 may include a soft cover 206 containing the door exit evacuation slide 208. Soft cover 206 may have lacing 210 to enclose the soft cover 206 and to retain the door exit evacuation slide 208. The lacing 210 may be in a daisy chain or speed lacing configuration and may be anchored through grommets 218.

In various embodiments, the soft cover 206 may be constructed from fabric materials such as nylon, polyester, aramid, para-aramid (KEVLAR), or other suitable materials providing adequate strength and durability while maintaining flexibility for rapid deployment. The lacing 210 may comprise cord, webbing, or cable constructed from materials such as nylon, polyester, or stainless steel cable. The grommets 218 may be constructed from brass, stainless steel, or reinforced polymer materials. The specific materials selected may depend on factors including the operating environment, desired service life, weight considerations, and regulatory requirements applicable to the specific aircraft type and certification basis.

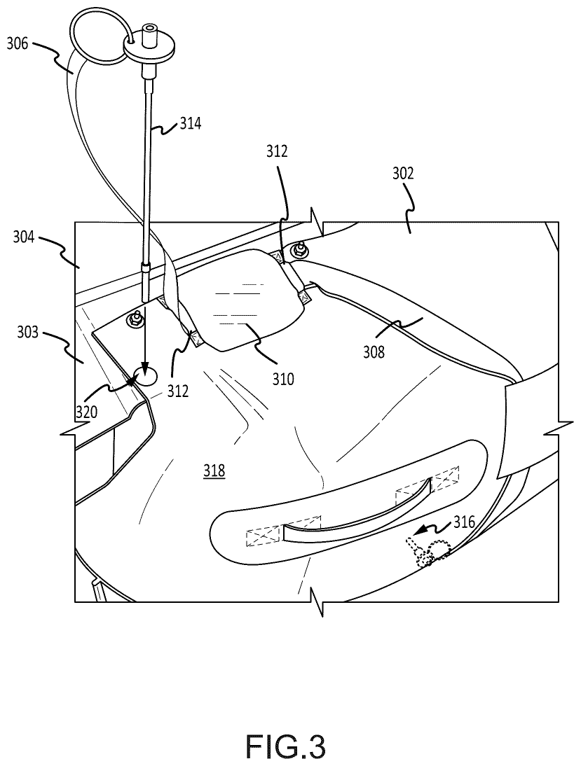

Referring now to FIG. 3, an isometric view an evacuation slide assembly that includes either an aircraft evacuation slide and/or slide/raft is illustrated, in accordance with various embodiments. In various embodiments, the evacuation slide assembly 302 is installed into a compartment 303 within an entry/exit door 304, such as aircraft entry/exit door 202 of FIG. 2, of the aircraft. In various embodiments, streamer 306 and streamer 308, with a rigid card 310 indicating, for example, “REMOVE BEFORE FLIGHT” mechanically coupled to the streamer 306 and the streamer 308, which are threaded through elastics 312 on either side of a gauge window. In various embodiments, the streamer 306 is mechanically coupled to a regulator safety pin 314, which is mechanically coupled to a charged cylinder through opening 320 through the soft cover 318 and the compartment 303 and is configured to prevent the charged cylinder from activating. In various embodiments, the streamer 308 is mechanically coupled to a latch safety pin 316. In various embodiments, the latch safety pin 316 is further coupled to soft cover “loops” installed over a torque tube pin. In that regard, in various embodiments, the latch safety pin 316 is coupled to a latch that controls the rotation of that torque tube and therefore, when in place, the latch safety pin 316 prevents rotation of the torque tube and subsequent release of the soft cover loops, which allow the slide to drop and inflate. In various embodiments, before the bustle is installed, the rigid card 310 pulls the streamer 308 in response to being removed, which removes the latch safety pin 316 thereby allowing rotation of the torque tube and subsequent release of the soft cover loops of the soft cover 318 in an emergency event. In various embodiments, as will be described hereafter, the latch safety pin 316 is utilized to remove the regulator safety pin 314 thereby allowing the charged cylinder to activate in an emergency event.

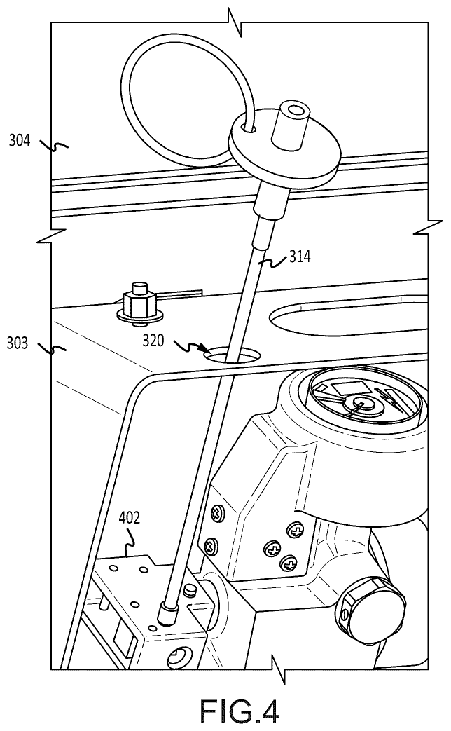

Referring now to FIG. 4, an isometric view of the regulator safety pin installed though a compartment in which the evacuation slide assembly is installed and into a regulator is illustrated, in accordance with various embodiments. In various embodiments, a distal end of the regulator safety pin 314 is installed though the opening 320 of the compartment 303 and into the regulator 402 of with the evacuation slide assembly. As stated previously, the regulator safety pin 314 prevents a charged cylinder in the regulator 402 from activating. In various embodiments, the regulator safety pin 314 protrudes through though the opening 320 of the compartment 303 and blocks installation of a bustle onto the entry/exit door 104 thereby preventing the bustle from covering the evacuation slide assembly until the regulator safety pin 314 is removed, as described hereafter.

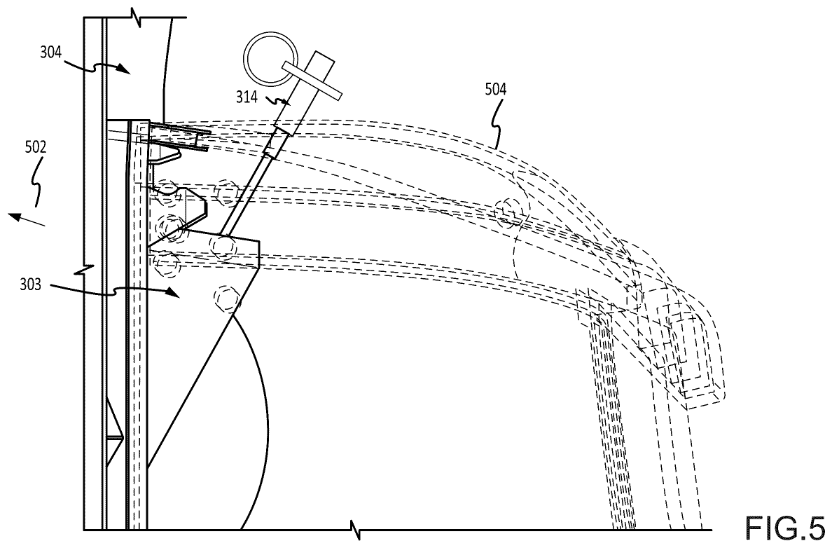

Referring now to FIG. 5, a side view of a regulator safety pin installed though a compartment in which the evacuation slide assembly is installed is illustrated, in accordance with various embodiments. In various embodiments, the regulator safety pin 314 protrudes through the opening 320 in the soft cover 318 of FIG. 3 and the compartment 303 of FIG. 4. In various embodiments, the regulator safety pin 314 interferes with the path 502 of the bustle 504 being installed into the entry/exit door 304 until the regulator safety pin 314 is removed.

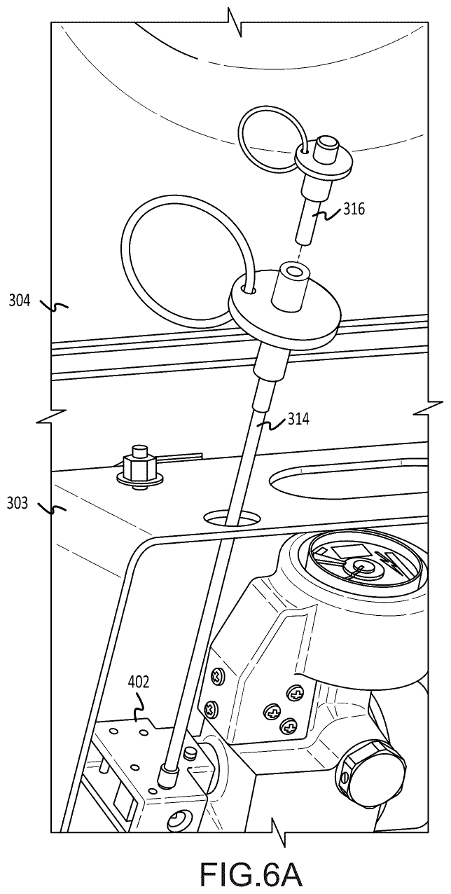

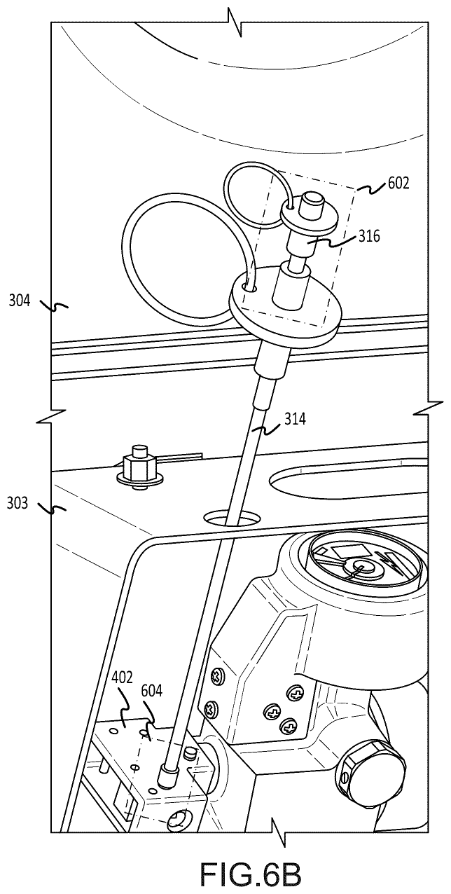

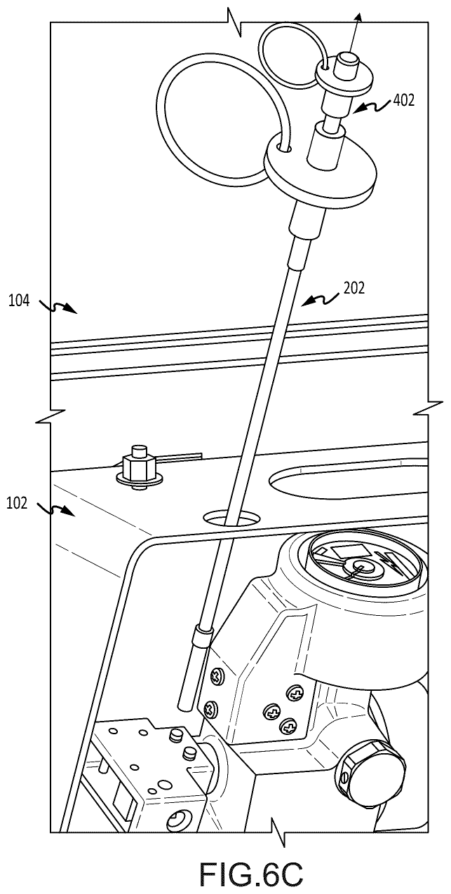

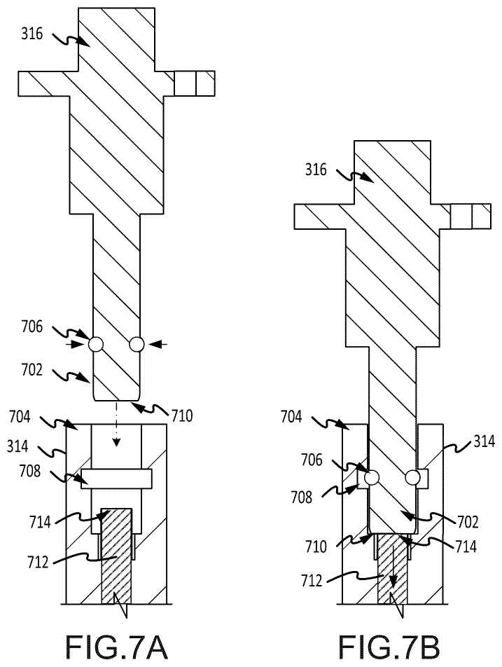

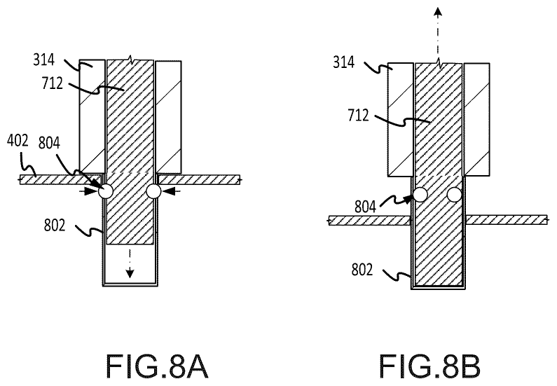

Referring now to FIGS. 6A, 6B, and 6C, isometric views of the removal of a regulator safety pin using a latch safety pin are illustrated, in accordance with various embodiments. In various embodiments, the latch safety pin 316, which prevents release of a soft cover for the aircraft evacuation slide and/or slide/raft, is coupled to a latch housing of the packboard. In various embodiments, the latch safety pin 316 is removed from a latch housing, thus enabling release of the soft cover for the aircraft evacuation slide and/or slide/raft during an emergency event. In various embodiments, with specific reference to FIG. 6A, the latch safety pin 316, once removed, is installed into a proximal end, i.e., an end opposite the distal end of the regulator safety pin 314 that is coupled to the regulator 402. In various embodiments, with specific reference to FIG. 6B as well as FIGS. 7A and 7B and FIGS. 8A and 8B, described in detail hereafter with regard to area 602 and area 604, respectively, as the latch safety pin 316 is installed into the proximal end of the regulator safety pin 314, the latch safety pin 316 translates an internal rod within the regulator safety pin 314, via a proximal end of the internal rod, so that detent balls adjacent a distal end of the internal rod of the regulator safety pin 314 are retracted thereby allowing the regulator safety pin to be removed. In various embodiments, with specific reference to FIG. 4C, with the detent balls adjacent the distal end of the internal rod of the regulator safety pin 314 retracted, the regulator safety pin 314 may be removed from the regulator 402 and the compartment 303 via the opening 320 in the compartment 303 and thus, allowing the bustle to be installed.

In various embodiments, the latch safety pin and regulator safety pin may be configured with different mechanical coupling mechanisms. For example, the latch safety pin may include a threaded engagement portion that interfaces with corresponding threads in the proximal end of the regulator safety pin. In further embodiments, the coupling may be achieved through a bayonet-style connection, a quick-release mechanism, or a magnetic coupling arrangement. Those skilled in the art will recognize that other positive-locking mechanisms may be employed without departing from the scope of the disclosure. Additionally, the number of detent balls may vary; in various embodiments, the regulator safety pin may include two, three, four, or more detent balls arranged circumferentially around the sleeve to provide uniform engagement with the regulator housing.

Referring now to FIGS. 7A and 7B, a cross-section view of the area 602 of FIG. 6 depicting the interface between a latch safety pin and a regulator safety pin is illustrated, in accordance with various embodiments. In various embodiments, a distal end 702 of the latch safety pin 316 is configured to be installed into the proximal end 704 of the regulator safety pin 314. In various embodiments, the distal end 702 of the latch safety pin 316 includes a set of detent balls 706 that are configured to retract toward a center of the latch safety pin 316 as the distal end 702 of the latch safety pin 316 enters the proximal end 704 of the regulator safety pin 314 and expand and latch into recess 708 adjacent the proximal end 704 of the regulator safety pin 314 as the distal end 702 of the latch safety pin 316 fully seats within the proximal end 704 of the regulator safety pin 314.

Additionally, in various embodiments, as the distal end 702 of the latch safety pin 316 is installed into the proximal end 704 of the regulator safety pin 314 a tip 710 of the latch safety pin 316 interfaces with a tip 714 of the internal rod 712 within the regulator safety pin 314 so as to translate the internal rod 712 away from the proximal end 704 of the regulator safety pin 314 so that a set of detent balls of the regulator safety pin 314 adjacent the proximal end of the regulator safety pin 314 retract thereby allowing the regulator safety pin 314 to be removed from the regulator, such as regulator 402 of FIG. 4, and allowing the charged cylinder to activate in an emergency event.

Referring now to FIGS. 8A and 8B, a cross-section view of the area 604 of FIG. 6 depicting the interface between a regulator safety pin and a regulator is illustrated, in accordance with various embodiments. In various embodiments, the distal end 702 of the regulator safety pin 314 includes a sleeve 802 with voids through which, in a first position, a set of detent balls 804 expand within a housing of the regulator 402 keeping the regulator safety pin 314 engaged and preventing the charged cylinder from activating. In that regard, in various embodiments, the diameter of the sleeve 802 with the set of detent balls 804 expanded through the voids is greater than an inside diameter of an opening in the housing of the regulator 402. As discussed previously with regard to FIGS. 7A and 7B, as the distal end 702 of the latch safety pin 316 is installed into the proximal end 704 of the regulator safety pin 314 a tip 710 of the latch safety pin 316 interfaces with a tip 714 of the internal rod 712 within the regulator safety pin 314 so as to translate the internal rod 712 away from the proximal end 704 of the regulator safety pin 314. In that regard, as the internal rod 712 translates away from the proximal end 704 of the regulator safety pin 314, the set of detent balls 804 retract into the sleeve 802 and the regulator safety pin 314 is allowed to be removed from the regulator 402 thereby allowing the charged cylinder to activate in an emergency event. Accordingly, an outside diameter of the sleeve 802 is less than inside diameter of an opening in the housing of the regulator 402. Moreover, by removing the regulator safety pin 314, the bustle 504 of FIG. 5 may be installed.

In various embodiments, the dimensional relationships between the components are selected to ensure proper function of the bustle blocker system. The diameter of the internal rod within the regulator safety pin may be between approximately 0.1 inches (2.5 mm) and 0.25 inches (6.4 mm), depending on the size of the detent balls and the required displacement for retraction. The detent balls may have a diameter between approximately 0.0625 inches (1.6 mm) and 0.1875 inches (4.8 mm). The sleeve at the distal end of the regulator safety pin may have an outer diameter that is approximately 0.02 inches (0.5 mm) to 0.05 inches (1.3 mm) less than the inner diameter of the opening in the regulator housing in response to the detent balls being retracted. These dimensional ranges are exemplary and may be adjusted based on specific application requirements, including the type of regulator, the size of the evacuation slide assembly, and the force required to engage and disengage the detent ball mechanisms. In various embodiments, springs or other biasing elements may be included within the regulator safety pin to bias the internal rod toward a position that maintains the detent balls in the expanded, engaged position until the latch safety pin is inserted.

Accordingly, in various embodiments, the first regulator safety pin prevents a technician's ability to install a bustle without first removing both a second latch safety pin and a first regulator safety pin. In various embodiments, by first having to remove the second latch safety pin in order to remove the first regulator safety pin, control is provided to an order that the second latch safety pin and the first regulator safety pin are removed since the second latch safety pin needs to be removed first and act as a key to remove the first regulator safety pin. In various embodiments, removing the second latch safety pin first is considered safer because the second latch safety pin does not interface with the regulator that would inflate the evacuation slide and/or slide/raft.

In various embodiments, the bustle blocker system may be retrofitted to existing aircraft evacuation systems by replacing the existing regulator safety pin with the modified regulator safety pin described herein, and by replacing or modifying the existing latch safety pin to include the mechanical coupling features. The retrofit process may be performed during scheduled maintenance intervals without incurring significant modifications to the aircraft door structure or the evacuation slide assembly. In various embodiments, the bustle blocker system may be installed as original equipment during aircraft manufacturing. In various embodiments, the bustle blocker system may be adapted for use with different types of evacuation assemblies, including single-lane slides, dual-lane slides, slide/raft combinations, and dedicated life rafts. The principles described herein are applicable to various aircraft types, including narrow-body aircraft, wide-body aircraft, regional jets, and business aviation aircraft.

Benefits and other advantages have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, and any elements that may cause any benefit or advantage to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 10%, within 5%, within 1%, within 0.1%, or within 0.01% of a stated value. Additionally, the terms “substantially,” “about,” or “approximately” as used herein represent an amount close to the stated amount that still performs a desired function or achieves a desired result. For example, the term “substantially,” “about,” or “approximately” may refer to an amount that is within 10% of, within 5% of, within 1% of, within 0.1% of, and within 0.01% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A system for preventing installation of a bustle until an evacuation slide assembly is enabled, comprising:
the evacuation slide assembly;
a latch safety pin mechanically coupled to a latch that is coupled to a soft cover of the evacuation slide assembly; and
a regulator safety pin mechanically coupled to a regulator of the evacuation slide assembly, wherein, responsive to removing the latch safety pin thereby allowing the soft cover to release in an emergency event, mechanically coupling the latch safety pin to the regulator safety pin thereby allowing the regulator safety pin to be removed allowing a charged cylinder to activate in the emergency event.

2. The system of claim 1, wherein a distal end of the latch safety pin, responsive to being inserted into a proximal end of the regulator safety pin, causes a set of detent balls adjacent a distal end of the regulator safety pin to be retracted.

3. The system of claim 2, wherein the set of detent balls adjacent the distal end of the regulator safety pin are retracted in response to the distal end of the latch safety pin interfacing with a tip of an internal rod in the regulator safety pin thereby translating the internal rod away from the proximal end of the regulator safety pin thereby causing the set of detent balls adjacent the distal end of the regulator safety pin to be retracted.

4. The system of claim 3, wherein the set of detent balls adjacent the distal end of the regulator safety pin is retracted into a sleeve at the distal end of the regulator safety pin.

5. The system of claim 2, wherein, prior to being retracted, the set of detent balls adjacent the distal end of the regulator safety pin expand within a housing of the regulator keeping the regulator safety pin engaged and prevent the charged cylinder from activating.

6. The system of claim 5, wherein the set of detent balls adjacent the distal end of the regulator safety pin expand within the housing through a sleeve at the distal end of the regulator safety pin.

7. The system of claim 2, wherein a second set of detent balls adjacent the distal end of the latch safety pin is configured to retract in response to being inserted into the proximal end of the regulator safety pin and latch into a recess adjacent the proximal end of the regulator safety pin.

8. The system of claim 1, wherein the evacuation slide assembly is located within a compartment of an aircraft.

9. The system of claim 1, wherein the evacuation slide assembly is located within a compartment on an entry/exit door of an aircraft.

10. The system of claim 9, wherein the regulator safety pin is configured to be mechanically coupled to the regulator of the evacuation slide assembly via an opening in the compartment of the entry/exit door of the aircraft.

11. An aircraft comprising:
an entry/exit door; and
a system for preventing installation of a bustle until an evacuation slide assembly is enabled, comprising:
the evacuation slide assembly;
a latch safety pin mechanically coupled to a latch that is coupled to a soft cover of the evacuation slide assembly; and
a regulator safety pin mechanically coupled to a regulator of the evacuation slide assembly, wherein, responsive to removing the latch safety pin thereby allowing the soft cover to release in an emergency event, mechanically coupling the latch safety pin to the regulator safety pin thereby allowing the regulator safety pin to be removed allowing a charged cylinder to activate in the emergency event.

12. The aircraft of claim 11, wherein a distal end of the latch safety pin, responsive to being inserted into a proximal end of the regulator safety pin, causes a set of detent balls adjacent a distal end of the regulator safety pin to be retracted.

13. The aircraft of claim 12, wherein the set of detent balls adjacent the distal end of the regulator safety pin are retracted in response to the distal end of the latch safety pin interfacing with a tip of an internal rod in the regulator safety pin thereby translating the internal rod away from the proximal end of the regulator safety pin thereby causing the set of detent balls adjacent the distal end of the regulator safety pin to be retracted.

14. The aircraft of claim 13, wherein the set of detent balls adjacent the distal end of the regulator safety pin are retracted into a sleeve at the distal end of the regulator safety pin.

15. The aircraft of claim 12, wherein, prior to being retracted, the set of detent balls adjacent the distal end of the regulator safety pin expand within a housing of the regulator keeping the regulator safety pin engaged and prevent the charged cylinder from activating.

16. The aircraft of claim 15, wherein the set of detent balls adjacent the distal end of the regulator safety pin expand within the housing through a sleeve at the distal end of the regulator safety pin.

17. The aircraft of claim 12, wherein a second set of detent balls adjacent the distal end of the latch safety pin are configured to retract in response to being inserted into the proximal end of the regulator safety pin and latch into a recess adjacent the proximal end of the regulator safety pin.

18. The aircraft of claim 11, wherein the evacuation slide assembly is located within a compartment of the aircraft.

19. The aircraft of claim 11, wherein the evacuation slide assembly is located within a compartment on the entry/exit door of the aircraft.

20. The aircraft of claim 19, wherein the regulator safety pin is configured to be mechanically coupled to the regulator of the evacuation slide assembly via an opening in the compartment of the entry/exit door of the aircraft.
